(19) United States
(12) Patent Application Publication
(10) Pub. No.: US 2011/0240613 A1
(43) Pub. Date: Oct. 6, 2011

(54) METHOD FOR PRODUCING SEALED BATTERY

(75) Inventors: Hiroshi HOSOKAWA, Kasai-shi (JP); Haruhiko YAMAMOTO, Kasai-shi (JP)

(73) Assignee: SANYO ELECTRIC CO., LTD., Osaka (JP)

(21) Appl. No.: 13/071,807

(22) Filed: Mar. 25, 2011

(30) Foreign Application Priority Data
Mar. 31, 2010 (JP) 2010-082970

(51) Int. Cl. B23K 26/00

(52) U.S. Cl. 219/121.64

(57) ABSTRACT

In a method for producing a sealed battery including irradiating a fitting portion between an outer can made of an aluminum-based metal and a sealing plate made of an aluminum-based metal and placed on a mouth portion of the outer can with a laser beam from continuous wave (CW) laser welding equipment for welding and sealing, the laser beam is output for scanning while pulse-modulating the output power of the laser beam in a welding start region, and then the laser beam is output for scanning at a constant output power. The present invention provides a method for producing a sealed battery by which welding start and stop regions are stably welded when an outer can and a sealing plate both of which are made of an aluminum-based metal are welded and sealed by a CW laser beam.

### TECHNICAL FIELD

The present invention relates to a method for producing a sealed battery, and in particular, relates to a method for producing a sealed battery in which an outer can and a sealing plate both of which are made of an aluminum-based metal having high thermal conductivity are welded and sealed by a continuous wave (CW) laser beam.

### BACKGROUND ART

With their high energy density and high capacity, sealed batteries, typified by the lithium ion secondary battery, are widely used as the power source for portable electronic equipment such as portable telephones, portable personal computers, and portable music players, and further as the drive power source for hybrid electric vehicles (HEVs) and electric vehicles (EVs).

This type of sealed battery is produced by forming a wound electrode assembly in which positive and negative electrode sheets are wound with a separator interposed therebetween, putting the wound electrode assembly into a battery outer can, fitting a sealing plate to a mouth portion of the battery outer can, laser-welding the fitting portion, pouring any electrolyte through an electrolyte pour hole, and sealing the electrolyte pour hole. Such method for fixing the sealing plate to the battery outer can by laser welding has been widely used because it has an advantage that the mouth portion of the battery outer can be sealed without reducing volumetric efficiency.

Examples of the system for generating laser include a CW laser generator, a pulsed laser generator, and a femtosecond laser generator. Among them, the femtosecond laser generator has a high peak output power of about 10,000,000 kW but has a pulse width of picoseconds or less. Thus, the laser beam has the average output power of several watts and the obtained energy is as small as about 1 mJ per pulse. Hence, the femtosecond laser generator is best suited for removing a surface layer but is unsuited for welding because its average output power is too small to melt metal.

The pulsed laser generator usually employs a flash lamp as an excitation source. It has a peak output power of about 15 kW, a pulse width of several milliseconds, the average output power of several hundred watts to about 1 kW, and an energy of about 150 J per pulse, and thus is suited for spot welding. Furthermore, seam welding can be performed when required by intermittently overlapping spot welded areas. However, because heat supplied by a previous pulse is diffused to the surrounding area and then the next pulse supplies heat, the processing speed is lower than that of a CW laser generator having the same average output power.

In contrast, the CW laser generator usually employs a laser diode as an excitation source. It has an output power of several thousand watts to about 10 kW and can perform the seam welding at high speed. When seam welding is performed, the welding speed becomes higher than that of the pulsed laser generator when the average output powers are the same because the heat for melting a new area is supplied from not only the heat produced by a laser beam but also the heat that is diffused from a previously melted area to the surrounding area. However, because it is readily affected by a melted area, it is difficult to maintain a proper welding condition in an unsteady area, for example, welding start and stop areas.

Hence, for the laser welding between the battery outer can and the sealing plate of a sealed battery, from the viewpoint of the need for laser welding at high speed for mass production, seam welding using CW laser welding equipment has been adopted in many cases. For example, JP-A-2008-84803 discloses a method for producing a sealed battery by which an outer can made of an aluminum-based metal can be sealed with a sealing plate at high speed. The method discloses a theoretical spot diameter and output density suitable when a CW laser beam is used. Seam welding can be performed at high speed by the method for producing a sealed battery disclosed in JP-A-2008-84803, even when both the outer can and the sealing plate are made of an aluminum-based metal having high thermal conductivity.

In the method for producing a sealed battery using the CW laser beam disclosed in JP-A-2008-84803, welding is started on a fitting portion of an outer can and a sealing plate at a constant laser output, and stopped on the fitting portion when the area melted by the CW laser irradiation passes the welding start area after it goes around the fitting portion. The state of the laser-welded area at this time will be described with reference to FIGS. 8A to 9D.

FIG. 8A is a plan view showing the fitting state between an outer can and a sealing plate of a prismatic sealed battery, FIG. 8B is an enlarged plan view of VIIIB where welding starts in FIG. 8A, FIG. 8C is an oblique cross-sectional view showing heat transfer in the fitting portion between the outer can and the sealing plate during the laser welding, FIG. 8D is an oblique cross-sectional view showing the welded state after the laser welding, and FIG. 8E is a schematic cross-sectional view of the melted area immediately after the start of welding. In the description below, enlarged plan views of the welding start region and the welding stop region between the outer can and the sealing plate show the same position as VIIIB in FIG. 8A. Furthermore, FIG. 9A is an enlarged plan view of the welding stop region, FIG. 9B is an oblique cross-sectional view immediately after the overlap, FIG. 9C is an oblique cross-sectional view of the welding stop region, and FIG. 9D is a schematic cross-sectional view of the melted area after the completion of welding.

In the method for producing a sealed battery 50 disclosed in JP-A-2008-84803, as shown in FIG. 8A, an outer can 51 is fitted with a sealing plate 52, a welding start region 54 in a fitting portion 53 between the outer can 51 and the sealing plate 52 is irradiated with a CW laser beam, and the CW laser beam is output for scanning along the fitting portion 53 between the outer can 51 and the sealing plate 52 at a constant speed with a constant laser output for laser welding. At this time, as shown in FIG. 8B and FIG. 9A, a continuous welded area 55 having an almost constant width is formed.

However, as shown in FIG. 8C, because the transfer manner of heat generated by the irradiation of a laser beam is different between the outer can 51 and the sealing plate 52, when the fitting portion 53 between the outer can 51 and the sealing plate 52 is irradiated with a laser beam, the temperature is increased to a greater degree in the outer can 51 in which heat is less diffused. Moreover, in the welding start region 54, as shown in FIG. 8E, there is a clearance between the outer can 51 and the sealing plate 52, and heat is not easily transferred between the outer can 51 and the sealing plate 52. Thus, the temperature of the outer can 51 is largely increased, and consequently, there is a problem that the outer can 51 is excessively melted to readily form a sagging 56 in a welded area 55 near the welding start region 54.

Furthermore, as shown in FIG. 8E, immediately before joining the outer can 51 to the sealing plate 52, a wide area in the edge of the outer can 51 and a narrow area in a part of the edge of the sealing plate 53 are independently melted, and each melted corner becomes round due to surface tension. As a result, the clearance may become wider than that before welding. Thus, the method for producing a sealed battery disclosed in JP-A-2008-84803 has a problem in that a welding defect is readily caused in the welding start region 54 because joining of the outer can 51 to the sealing plate 52 starts from the position having such wide clearance.

Moreover, as shown in FIG. 9A, the previously welded area 55 is irradiated with a laser beam once again until the welding reaches a welding stop position 57 to form an overlap area (welding stop region) 58. A laser beam is less absorbed into the previously welded area 55 as compared with an unwelded area, and thus the melting may be insufficient in the overlap area 58. In addition, a hollow, wrinkle 59, or the like is formed in the melted area to form an area having a low welding depth at the laser welding stop position 57, as shown in FIG. 9C and FIG. 9D, and thus there is a problem that a welding defect is more readily caused at the welding stop position 57 than in a usual welded area.

### SUMMARY

An advantage of some aspects of the invention is to provide a method for producing a sealed battery by which welding start and stop regions are stably welded when an outer can and a sealing plate both of which are made of an aluminum-based metal are welded and sealed by a CW laser beam from CW laser welding equipment used in a production process of sealed batteries.

According to an aspect of the invention, a method for producing a sealed battery includes irradiating a fitting portion between an outer can made of an aluminum-based metal and a sealing plate made of an aluminum-based metal and placed on a mouth portion of the outer can with a laser beam from CW laser welding equipment for welding and sealing. In the method for producing a sealed battery, the laser beam is output for scanning while pulse-modulating an output power of the laser beam in a welding start region, and then the laser beam is output for scanning at a constant output power.

Usually, in a sealed battery in which a sealing plate is placed on a mouth portion of a cylindrical outer can having a bottom and a fitting portion between the outer can and the sealing plate is laser-welded to seal the outer can, a side wall portion (welding area) of the outer can has a smaller cross-sectional thickness than the thickness of the sealing plate. Commonly, the welding area of the outer can has a cross-sectional thickness of about 0.2 to 1 mm, and the sealing plate has a thickness of about 1 to 2 mm. Thus, when the fitting portion is heated with a laser beam, the outer can is rapidly heated to mainly melt the outer can itself, but in the sealing plate, the heat is mainly diffused into the sealing plate by thermal conductivity and consequently the temperature increase is slow in the welded area. Furthermore, when the output power of a laser beam from CW laser welding equipment is pulse-modulated, the average output power becomes lower than that of a laser beam having a constant output power from the CW laser welding equipment.

In the method for producing a sealed battery according to the aspect of the invention, CW laser welding equipment is used, a laser beam is output for scanning while pulse-modulating the output power of the laser beam in a welding start region, and then the laser beam is output at a constant output power. When such method is adopted, the outer can is joined to the sealing plate without melting an edge across the width of the outer can in the welding start region when the output power of a laser beam pulse is high, such that the heat in the outer can reaches the sealing plate when the output power of a laser beam pulse is low, and consequently the temperature of the sealing plate is increased. When the laser beam is output for scanning while pulse-modulating the output power of the laser beam, the temperature of the outer can becomes substantially the same as that of the sealing plate after several pulses. As a result, when the CW laser beam is output for scanning at a constant output power after that, excessive melting of the outer can alone is suppressed because the outer can and the sealing plate have the same temperature.

Therefore, by the method for producing a sealed battery according to the aspect of the invention, even when both the outer can and the sealing plate are made of an aluminum-based metal having high thermal conductivity, a sealed battery in which sagging is not readily formed as well as a welding defect is not readily formed in the welding start region can be produced using a laser beam having a constant output power from CW laser welding equipment. In addition, continuous welding is started on the fitting portion between the outer can and the sealing plate as the welding start region while maintaining a high temperature in the sealing plate because the laser beam is output for scanning while pulse-modulating the output power of the laser beam and then the laser beam is output at a constant output power, and consequently the phenomenon that only the outer can is mostly melted can be further suppressed.

A modulation pattern for pulse-modulating the output power is preferably a rectangular wave pattern. However, if the output power is rapidly changed, a laser diode as an excitation source of the CW laser equipment may have a shorter lifetime. Thus, it is preferable that the output power not be reduced to 0%. Moreover, the time for changing the output power may be increased. In this case, the output power may be changed in a triangular wave pattern in order to increase the time for changing the output power as long as possible.

In the present specification, the phrase that a laser beam is output for scanning at a “constant” output power does not always mean that a laser beam is output at 100% of the output power from start to finish. For example, in a later welding, because the temperature is increased near a melted area, 100% of the output power may provide excessive melting. In such case, the output power of the laser beam may be properly reduced by several percent, specifically about 1 to 3%, and in the present specification, the term of “constant” includes such case.

In the invention, preferred welding conditions are as follows.
Output power of laser beam: 1.2 kW to 6.0 kW
Theoretical spot diameter: 0.2 to 1.0 mm
Moving speed (constant output power region): 50 to 250 mm/second
Moving speed (pulse modulation region): 3.5 to 50 mm/second
   (More Preferably 5 to 50 Mm/Second)

In the method for producing a sealed battery according to the aspect of the invention, it is preferable that the welding start region be set on the sealing plate, that the irradiation of the laser beam be started on the sealing plate, that the laser beam be output for scanning to reach the fitting portion between the outer can and the sealing plate while pulse-modulating the output power of the laser beam, and that immediately after that or after the laser beam is output for scanning above the fitting portion beyond a predetermined distance, the laser beam be output for scanning at a constant output power.

If the welding start region is set on the sealing plate, the sealing plate is first gradually heated by the pulse-modulated laser beam, and thus when the laser beam is output for scanning to reach the fitting portion between the outer can and the sealing plate, the sealing plate reaches a high temperature. As a result, even if the laser beam is output at a constant output power immediately after that or after the laser beam is output for scanning above the fitting portion beyond a predetermined distance, continuous welding is started on the fitting portion between the outer can and the sealing plate while maintaining a high temperature in the sealing plate. Hence, the phenomenon that only the outer can is greatly melted can be further suppressed.

In the method for producing a sealed battery according to the aspect of the invention, it is preferable that the output power of the laser beam be gradually increased at a valley of the pulse-modulated output power.

When the output power of the laser beam is gradually increased at a valley of the pulse-modulated output power, the average output power of the laser beam is gradually increased. With the progress of the irradiation of a pulse-modulated laser beam, the temperature of the sealing plate is increased. Thus, if the output power of the laser beam is gradually increased at a valley of the pulse-modulated output power, the temperature of the sealing plate can be increased for a shorter period. Therefore, the production efficiency of sealed batteries can be improved by the method for producing a sealed battery according to the aspect of the invention, in addition to the advantages above.

In the method for producing a sealed battery according to the aspect of the invention, it is preferable that, in a welding stop region on the fitting portion between the outer can and the sealing plate, the laser beam be output for scanning while pulse-modulating the output power of the laser beam from an area immediately before overlap of the welded areas to at least an area immediately after the overlap.

When a laser beam LB is applied once again to an area where the laser beam LB has been applied to melt the surface in the sealing plate and the outer can made of an aluminum-based metal, the absorption factor of the laser beam LB is smaller in the area where the laser beam LB has been applied than in an area where no laser beam LB has been applied for melting. Thus, the previously irradiated area has a tendency to have lesser penetration between the outer can and the sealing plate. In the method for producing a sealed battery according to the aspect of the invention, in the welding stop region on the fitting portion between the outer can and the sealing plate, the laser beam is output for scanning while pulse-modulating the output power of the laser beam from an area immediately before overlap of the welded areas to at least an area immediately after the overlap. When the laser beam is output while pulse-modulating the output power of the laser beam, the average output power of the laser beam becomes smaller than that when the output power of the laser beam is constant, and consequently the amount of heat input is reduced. Thus, in order to supply a predetermined amount of heat to the welding area, the scanning speed is required to be low. Adopting such a method makes the welding speed low, but also makes the outer can ready to obtain large penetration without sagging, and makes it difficult for the surface to be affected by whether the surface is welded. Therefore, insufficient melting near the overlap area can be avoided.

In the method for producing a sealed battery according to the aspect of the invention, it is preferable that in the welding stop region on the fitting portion between the outer can and the sealing plate, after the welded areas are overlapped, the laser beam be output for scanning from the fitting portion between the outer can and the sealing plate to the sealing plate while pulse-modulating the output power of the laser beam and be stopped on the sealing plate.

In the welding stop region, when the irradiation of a laser beam is stopped after the welded areas are overlapped, the temperature is suddenly changed at the area where the irradiation of a laser beam is stopped, and thus a hollow or wrinkle is readily formed. In particular, melt depth is insufficient at the bottom of the hollow or wrinkle causing reduced welding strength. By the method for producing a sealed battery according to the aspect of the invention, after the welded areas are overlapped, the laser beam is output for scanning from the fitting portion between the outer can and the sealing plate to the sealing plate while pulse-modulating the output power of the laser beam and is stopped on the sealing plate. As a result, the area where the irradiation of a laser beam is stopped is on the sealing plate. Thus, even when a hollow, wrinkle, or the like is formed, it is separated from the fitting portion between the outer can and the sealing plate. Therefore, the welding strength between the outer can and the sealing plate can be maintained, the welded area obtains high-strength, and electrolyte leakage from the sealed battery can be suppressed.

In the method for producing a sealed battery according to the aspect of the invention, it is preferable that the output power of the laser beam in the welding stop region be gradually reduced at a valley of the pulse-modulated output power.

When the laser beam is pulse-modulated after the laser beam is output for scanning at a constant output power, the temperature of the sealing plate is gradually decreased with the progress of the scanning. Consequently, it is difficult for a hollow, wrinkle, or the like to be formed in the melted area of the welding stop region, and therefore it is also difficult for a welding defect to occur.

According to another aspect of the invention, a method for producing a sealed battery includes irradiating a fitting portion between an outer can made of an aluminum-based metal, and a sealing plate made of an aluminum-based metal and placed on a mouth portion of the outer can with a laser beam from continuous wave laser welding equipment for welding and sealing. In the method for producing a sealed battery, in a welding stop region on the fitting portion between the outer can and the sealing plate, the laser beam is output for scanning while pulse-modulating an output power of the laser beam from an area immediately before overlap of welded areas to an area immediately after the overlap.

In the sealing plate and the outer can made of an aluminum-based metal, when a laser beam LB is applied once again to an area where the laser beam LB has been applied to melt the surface, the absorption factor of the laser beam LB is smaller in the area where the laser beam LB has been applied than in an area where no laser beam LB has been applied for melting. Thus, the previously irradiated area has a tendency to have lesser penetration between the outer can and the sealing plate. In the method for producing a sealed battery according to the aspect of the invention, in the welding stop region on the fitting portion between the outer can and the sealing plate, the laser beam is output for scanning while pulse-modulating the output power of the laser beam from an area immediately before the overlap of the welded areas to at least an area immediately after the overlap. Adopting such method makes the welding speed low, but also makes the outer can ready to obtain large penetration without sagging, and makes it difficult for the surface to be affected by whether the surface is welded. Therefore, insufficient melting near the overlap area can be avoided. In the welding stop region, the number of pulses is preferably about 5 to 20 pulses in a section where the laser beam is overlapped.

In the method for producing a sealed battery according to the aspect of the invention, it is preferable that in the welding stop region on the fitting portion between the outer can and the sealing plate, after the welded areas are overlapped, the laser beam be output for scanning from the fitting portion between the outer can and the sealing plate to the sealing plate while pulse-modulating the output power of the laser beam and be stopped on the sealing plate.

In the welding stop region on the fitting portion between the outer can and the sealing plate, when the irradiation of a laser beam is stopped after the welded areas are overlapped, the temperature is suddenly changed at the area where the irradiation of a laser beam is stopped, and thus a hollow or wrinkle is readily formed. In particular, melt depth is insufficient at the bottom of the hollow or wrinkle to reduce welding strength. By the method for producing a sealed battery according to the aspect of the invention, after the welded areas are overlapped, the laser beam is output for scanning from the fitting portion between the outer can and the sealing plate to the sealing plate while pulse-modulating the output power of the laser beam and is stopped on the sealing plate. As a result, the area where the irradiation of a laser beam is stopped is on the sealing plate. Thus, even when a hollow, wrinkle, or the like is formed, it is separated from the welded area between the outer can and the sealing plate. Therefore, the welding strength between the outer can and the sealing plate can be maintained, the welded area obtains high-strength, and electrolyte leakage from the sealed battery can be suppressed. If the output power is gradually reduced during stopping the irradiation of a laser beam, a smaller hollow is formed in the melted area. Thus, it is preferable that an output power is reduced to 70% or less after the beam is output for scanning from the fitting face for stopping the irradiation of a laser beam.

### BRIEF DESCRIPTION OF THE DRAWINGS

The invention will be described with reference to the accompanying drawings, wherein like numbers reference like elements.

FIG. 1 is a perspective view of a sealed battery common to each embodiment.

FIG. 2A is a front view showing an internal structure of the secondary battery in FIG. 1, and FIG. 2B is a cross-sectional view along the line IIB-IIB in FIG. 2A.

FIG. 3A is an enlarged plan view of a welding start region in a first embodiment of the invention, FIG. 3B is an oblique cross-sectional view immediately after the start of welding, FIG. 3C is a schematic cross-sectional view showing heat transfer, and FIG. 3D is an oblique cross-sectional view of a welding start region.

FIG. 4A is a waveform example when the output power at a valley is gradually increased in a pulse modulation having a rectangular wave pattern, and FIG. 4B is a waveform example when the output power at a valley is gradually increased in a pulse modulation having a triangular wave pattern.

FIG. 5A is an enlarged plan view of a welding start region in a second embodiment of the invention, FIG. 5B is an oblique cross-sectional view of the welding start region in the second embodiment, and FIG. 5C is an enlarged plan view of the welding start region in an alternate embodiment of the second embodiment.

FIG. 6A is an enlarged plan view of a welding stop region in a third embodiment of the invention, FIG. 6B is an oblique cross-sectional view of the welding stop region, and FIG. 6C is a schematic cross-sectional view of the melted area after the completion of welding.

FIG. 7A is an enlarged plan view of a welding stop region in a fourth embodiment of the invention, FIG. 7B is an oblique cross-sectional view of the welding stop region, FIG. 7C is a schematic cross-sectional view of the melted area after the completion of welding, and FIG. 7D is an enlarged plan view of the welding stop region in an alternate embodiment of the fourth embodiment.

FIG. 8A is a plan view showing the fitting state between an outer can and a sealing plate of a prismatic sealed battery, FIG. 8B is an enlarged plan view of VIIIB where welding starts in FIG. 8A, FIG. 8C is an oblique cross-sectional view showing heat transfer in the fitting portion between the outer can and the sealing plate during the laser welding, FIG. 8D is an oblique cross-sectional view showing the welded state after the laser welding, and FIG. 8E is a schematic cross-sectional view of the melted area immediately after the start of welding.

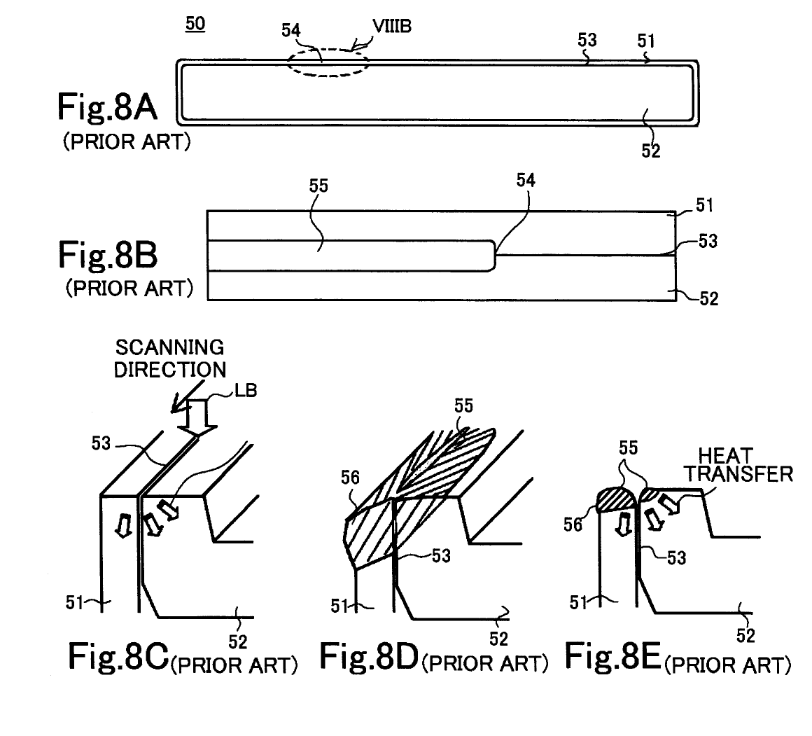

FIG. 9A is an enlarged plan view of the welding stop region, FIG. 9B is an oblique cross-sectional view immediately after the overlap, FIG. 9C is an oblique cross-sectional view of the welding stop region, and FIG. 9D is a schematic cross-sectional view of the melted area after the completion of welding.

### DESCRIPTION OF EXEMPLARY EMBODIMENTS

Hereinafter, embodiments of the present invention will be described with reference to the accompanying drawings. However, the embodiments described below are merely illustrative examples of prismatic nonaqueous electrolyte secondary batteries in which an outer can is welded to a sealing plate using a laser beam, as a sealed battery for embodying the technical spirit of the invention. The invention is not intended to be limited to the prismatic nonaqueous electrolyte secondary batteries. The invention can be equally applied to sealed batteries in other embodiments within the scope of the claims, such as cylindrical-shaped and elliptic cylindrical-shaped nonaqueous electrolyte secondary batteries.

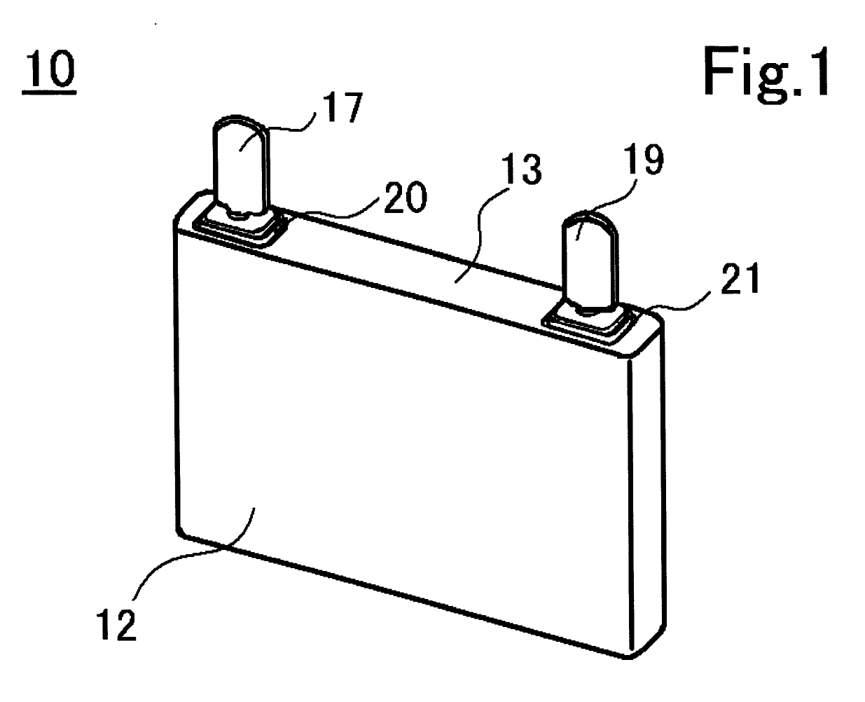

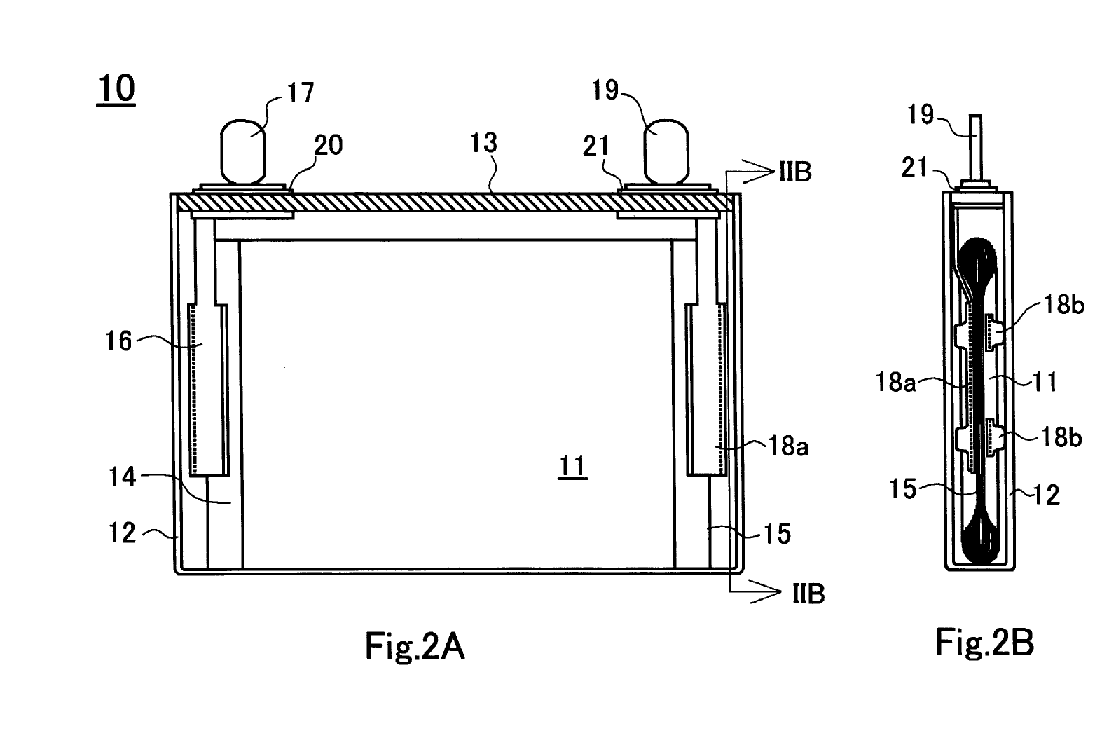

First, the structure of a prismatic nonaqueous electrolyte secondary battery used as a sealed battery in each embodiment will be described with reference to FIG. 1 and FIGS. 2A and 2B. FIG. 1 is a perspective view of a prismatic nonaqueous electrolyte secondary battery as a sealed battery common to each embodiment. FIG. 2A is a front view showing an internal structure of the prismatic nonaqueous electrolyte secondary battery in FIG. 1, and FIG. 2B is a cross-sectional view along the line IIB-IIB in FIG. 2A.

A prismatic nonaqueous electrolyte secondary battery 10 is prepared by placing a flat wound electrode assembly 11 in which positive and negative electrode sheets in the drawings are wound with a separator interposed therebetween (all of which are not shown), into a prismatic outer can 12, and sealing the outer can 12 with a sealing plate 13. Both the outer can 12 used and the sealing plate 13 used are made of an aluminum-based metal having high thermal conductivity.

The positive electrode sheet is prepared, for example, by applying a positive electrode active material mixture containing LiCoO₂ as positive active material on both sides of a positive electrode substrate made of aluminum foil or the like so as to form a positive electrode substrate exposed portion 14 where strip-shaped aluminum foil is exposed, drying the resulting substrate, and then rolling it with pressure applied thereto. The negative electrode sheet is prepared, for example, by applying a negative electrode active material mixture containing black lead as negative active material on both sides of a negative electrode substrate made of copper foil or the like so as to form a negative electrode substrate exposed portion 15 where strip-shaped copper foil is exposed, drying the resulting substrate, and then rolling it with pressure applied thereto. The flat wound electrode assembly 11 is prepared by flatly winding the positive and negative electrode sheets with a polyethylene porous separator (not shown) interposed therebetween so that the positive electrode substrate exposed portion 14 is exposed at one end in the winding axis direction and the negative electrode substrate exposed portion 15 is exposed at the other end in the winding axis direction.

The positive electrode substrate exposed portion 14 is connected to a positive electrode terminal 17 through a positive electrode collector member 16, and the negative electrode substrate exposed portion 15 is connected to a negative electrode terminal 19 through negative electrode collector members 18a and 18b. The positive electrode terminal 17 and the negative electrode terminal 19 are fixed to the sealing plate 13 through insulating members 20 and 21, respectively. The prismatic nonaqueous electrolyte secondary battery 10 is manufactured by inserting the flat wound electrode assembly 11 into the prismatic outer can 12, laser-welding the sealing plate 13 to a mouth portion of the outer can 12, then pouring a nonaqueous electrolyte through an electrolyte pour hole, and sealing up the electrolyte pour hole. A plane view of the prismatic nonaqueous electrolyte secondary battery 10 in each embodiment is not shown because it is the same as that of the related art prismatic sealed battery shown in FIG. 2A.

### First Embodiment

### Welding Start Region

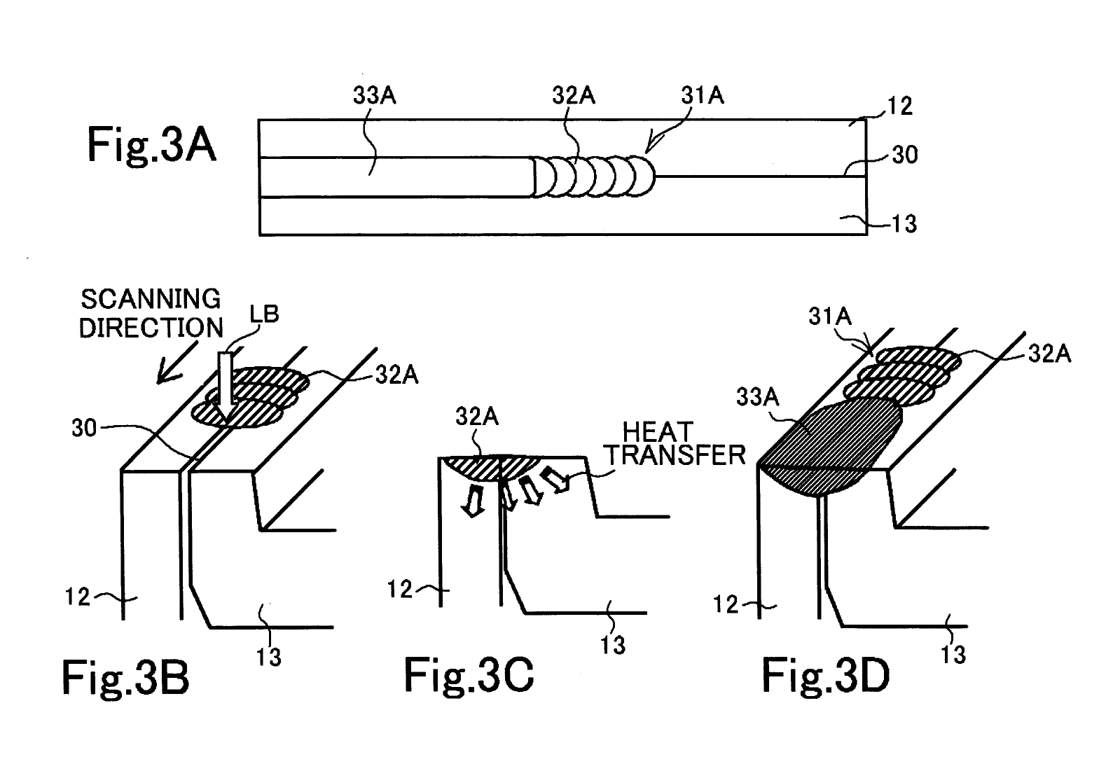

The welded state in a welding start region in a method for producing a sealed battery in a first embodiment of the invention will be described with reference to FIGS. 3A to 3D. FIG. 3A is an enlarged plan view of a welding start region in the first embodiment, FIG. 3B is an oblique cross-sectional view immediately after the start of welding, FIG. 3C is a schematic cross-sectional view showing heat transfer, and FIG. 3D is an oblique cross-sectional view of the welding start region.

In the welding start region of a sealed battery of the first embodiment, as shown in FIG. 3A and FIG. 3B, after the outer can 12 is fitted to the sealing plate 13, firstly, a welding start region 31A in a fitting portion 30 between the outer can 12 and the sealing plate 13 is irradiated with a laser beam LB from CW laser welding equipment (not shown) while pulse-modulating the beam, and the pulse-modulated laser beam LB is output for scanning along the fitting portion 30 between the outer can 12 and the sealing plate 13. As a result, in the welding start region 31A, spots of weld marks 32A are intermittently formed on the fitting portion 30 between the outer can 12 and the sealing plate 13. Then, the laser beam LB having a constant output power is output at a constant speed to form a continuous weld mark 33A.

Each thickness of the outer can and the sealing plate made of an aluminum-based metal and the features of the CW laser welding equipment used in the first embodiment are as follows.
Thickness of outer can: 0.5 mm
Thickness of sealing plate: 1.4 mm
Laser beam output power: 1.9 kW
Theoretical spot diameter: about 0.6 mm
Moving speed (constant output power region): 60 mm/second
Moving speed (pulse modulation region): 20 mm/second

The outer can 12 used for the sealed battery of the first embodiment has a thickness of 0.5 mm, and the sealing plate 13 has a thickness of 1.4 mm. Thus, in the welding start region 31A, as shown in FIG. 3C, the thermal diffusion in the outer can 12 is smaller than that in the sealing plate 13. However, here, the laser beam LB is output for scanning at a constant speed while pulse-modulating the output power. As a result, in the welding start region 31A, the outer can 12 is joined to the sealing plate 13 without melting an edge across the width of the outer can 12 when the output power of the first laser beam LB pulse is high, and then the heat in the outer can 12 reaches the sealing plate 13 when the output power of the laser beam LB pulse is small. Hence, when the laser beam LB is output at a constant speed while pulse-modulating the output power during several pulses, the temperature of the outer can 12 becomes substantially the same as that of the sealing plate 13. Thus, when the laser beam LB is output for scanning at a constant output power after that, excessive melting of the outer can 12 alone can be suppressed because the outer can 12 and the sealing plate 13 have the same temperature.

Therefore, by the method for producing a sealed battery in the first embodiment, even when both the outer can 12 and the sealing plate 13 are made of an aluminum-based metal having high thermal conductivity, a sealed battery in which sagging is not readily formed and a welding defect is not readily formed in the welding start region 31A can be produced using the laser beam LB from CW laser welding equipment. In addition, in the method, the laser beam LB is output for scanning at a constant speed while pulse-modulating the output power in the welding start region 31A, and then the laser beam LB is output at a constant output power, that is, at 100% of the output power, at a higher constant speed. As a result, the continuous weld mark 33A is formed on the fitting portion 30 between the outer can 12 and the sealing plate 13 while maintaining a high temperature in the sealing plate 13. Therefore, the phenomenon that only the outer can 12 is largely melted can be further suppressed as well as the welding can be performed at high speed.

The pulse modulation of the output power of the laser beam LB can be performed theoretically between 0% and 100% in a rectangular wave pattern. However, if the output power is rapidly changed, a laser diode used as an excitation source of the CW laser equipment may have a shorter lifetime. Thus, it is preferable that the output power not be reduced to 0% at the valley in the output power of the laser beam LB. To address this, the output power of the laser beam LB is set at, for example, about 2% at the valley, and modulated between about 2% and 100% in a rectangular wave pattern. The pulse modulation is performed, for example, as follows: the output power is started from about 2% and increased to 100% within several milliseconds; 100% of the output power is maintained for 3 to 30 mS; then the output power is reduced to about 2% within several milliseconds; and such rectangular wave modulation is regarded as 1 pulse and repeated. For the next pulse, the irradiation position is shifted by 0.1 to 0.5 mm and a similar pulse irradiation of the laser beam LB is performed.

At this time, the number of pulses until the laser beam LB is output for scanning to reach a welding area where the irradiation is performed at a constant output power and at a constant speed, that is, the number of pulses during output of the laser beam LB at a constant speed while pulse-modulating the output power is preferably about 5 to 20 pulses. This is because, when the area where the output power of the laser beam LB is pulse-varied in the welding start region 31A is too small, the sealing plate 13 is not sufficiently heated, consequently, the advantages of the invention are not fully obtained, and a welding defect is readily caused in the welding start region 31A. In contrast, when the pulse-varied area is too large, the welding is performed at a low speed in an area where the welding could be performed at a high speed under normal circumstances, and thus the efficiency is reduced. If the pitch for each pulse is set, for example, to 0.2 mm, when 10 pulses of the laser beam LB are applied to the welding start region 31A, the welding start region 31A will have a length of 2 mm. The pitch for each pulse may be about 0.1 to 0.5 mm, the number of irradiation pulses may be about 5 to 20 pulses, and the length of the welding start region 31A may be about 0.5 to 10 mm.

In addition to the modulation with the rectangular wave pattern for the output power of the laser beam LB, the modulation may be performed in a triangular wave pattern in order to elongate the time for varying the output power as long as possible. In this case, the output power variation is performed, for example, as follows: the output power is increased from about 2% to 100% for 10 to 20 mS; and is reduced from 100% to about 2% for 10 to 20 mS. In this case, the scanning distance for each pulse may be about 0.2 mm.

Hundred percent of the output power may provide excessive melting when the laser beam LB is output for scanning at a constant output power and at a constant speed because the temperature is increased near the melted area in a later welding. In such case, the output power may be reduced by several percent, specifically about 1 to 3%.

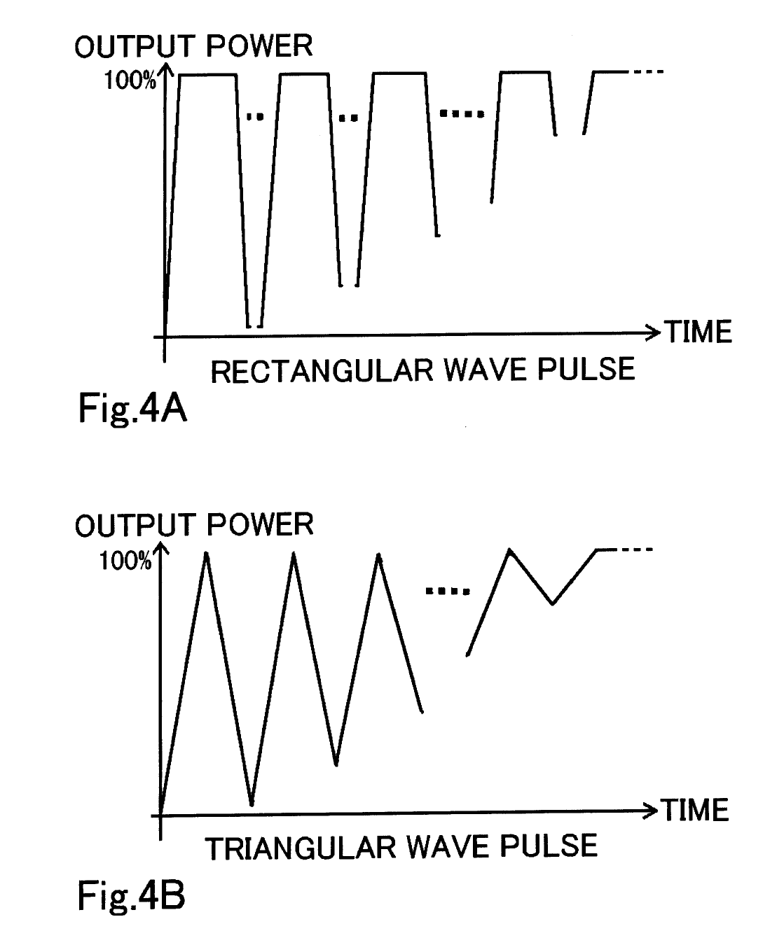

For the pulse modulation of the output power of the laser beam LB, the output power at the valley in each pattern may be gradually increased in both the modulations with a rectangular wave pattern and with a triangular wave pattern as shown in FIG. 4A and FIG. 4B. When the output power at the valley is gradually increased during the pulse-modulation of the output power of the laser beam LB, the average output power of the laser beam is gradually increased, and thus the temperature in the sealing plate 13 is greatly increased in accordance with the progress of the irradiation of the pulse-modulated laser beam LB. Accordingly, when the output power at the valley is gradually increased during the pulse-modulation of the output power of the laser beam LB, the temperature in the sealing plate 13 can be increased for a short period. As a result, the length of the welding start region 31A becomes shorter, the welding can be shifted for a short period to a high speed welding step in which the laser beam LB is output for scanning at a constant output power, and therefore the production efficiency of sealed batteries can be improved.

For the pulse modulation in this case, when the output power at the valley is reduced to about 2% in the initial pulse, the output power at the valley is increased to, for example, about 10 to 20% in the next pulse. Then, the output power at the valley is gradually increased for each pulse irradiation, and finally the output power becomes continuously constant. In this way, the welding can be shifted to the high speed welding step using a laser beam having a normal constant output power. The pulse output power at the valley right before the constant output power is preferably about 70 to 95%. This is because when the output power in the portion is too far from 100%, the difference from the subsequent continuous constant output power is too large, and thus a defect is readily caused in the welding start area. Furthermore, when a pulse over 95% is repeated over required times, the welding is performed at a low speed in an area where the welding could be performed at a high speed, and thus the efficiency is reduced.

### Second Embodiment

### Welding Start Region

The method for producing a sealed battery in the first embodiment shows an example in which the welding start region 31A is the fitting portion 30 between the outer can 12 and the sealing plate 13. However, even when a laser beam is output for scanning at a constant speed while pulse-modulating the output power of the laser beam in the welding start region 31A, a certain amount of time is required until the temperature of the sealing plate 13 becomes almost the same as that of the outer can 12. Thus, during that time, a welding defect may be caused on the fitting portion 30 in the welding start region 31A

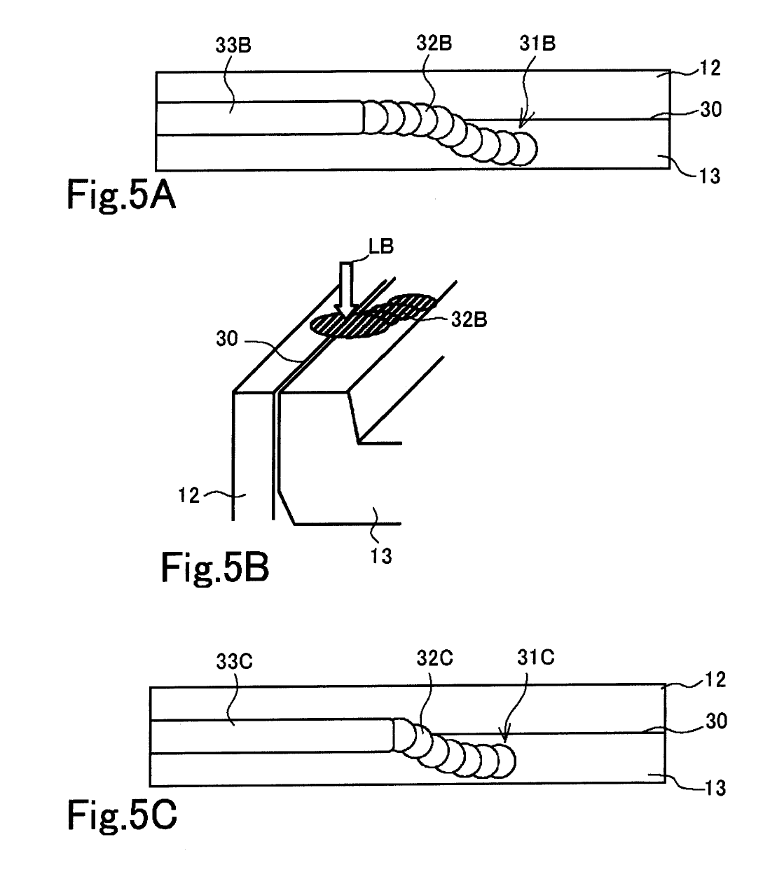

Therefore, in a method for producing a sealed battery in a second embodiment of the invention, the welding start region is set on the sealing plate. The method for producing a sealed battery in the second embodiment will be described using FIGS. 5A to 5C. FIG. 5A is an enlarged plan view of a welding start region in the second embodiment, FIG. 5B is an oblique cross-sectional view of the welding start region in the second embodiment, and FIG. 5C is an enlarged plan view of the welding start region in an alternate embodiment of the second embodiment.

In the method for producing a sealed battery in the second embodiment, a welding start region 31B is set on the sealing plate 13, and the irradiation of the laser beam LB is started on the sealing plate 13 and reaches the fitting portion 30 between the outer can 12 and the sealing plate 13 while pulse-modulating the output power of the laser beam LB in a rectangular wave pattern, and further reaches a certain region on the fitting portion 30 between the outer can 12 and the sealing plate 13 at a constant speed. As a result, spots of weld marks 32B are formed. Then, the laser beam LB is output at a constant output power, that is, at 100% of the output power, along the fitting portion 30 between the outer can 12 and the sealing plate 13 at a higher constant speed. As a result, a continuous weld mark 33B is formed.

In this case, for the pulse modulation of the laser beam LB, the output power is set at about 2% at the valley of the laser beam LB, and is modulated between about 2% and 100% in a rectangular wave pattern. The pulse modulation is performed, for example, as follows: the output power is started from about 2% and increased to 100% within several milliseconds; 100% of the output power is maintained for 3 to 30 mS; then the output power is reduced to about 2% within several milliseconds; and such rectangular wave modulation is regarded as 1 pulse and repeated. For the next pulse, the irradiation position is shifted by 0.1 to 0.5 mm and a similar pulse irradiation of the laser beam LB is performed.

When the welding start region 31B is set on the sealing plate 13, firstly, the sealing plate 13 is gradually heated by the pulse modulated laser beam LB. Thus, when the laser beam LB is output for scanning to reach the fitting portion 30 between the outer can 12 and the sealing plate 13, the temperature of the sealing plate 13 increases. As a result, even when the laser beam LB is output at a constant output power at a higher constant speed after that, the welding is started at a constant output power on the fitting portion 30 between the outer can 12 and the sealing plate 13 while maintaining a high temperature in the sealing plate 13. Consequently, a continuous weld mark 33B in which the outer can 12 and the sealing plate 13 are properly melted can be formed, and therefore the phenomenon that only the outer can 12 is largely melted can be further suppressed. Alternatively, the welding start region 31B is set on the sealing plate 13, the irradiation of the laser beam LB is started on the sealing plate 13 and reaches the fitting portion 30 between the outer can 12 and the sealing plate 13 while pulse-modulating the output power of the laser beam LB in a rectangular wave pattern, and immediately after that, the laser beam LB may be output at a constant output power at a higher constant speed along the fitting portion 30 between the outer can 12 and the sealing plate 13.

Even when the welding start region 31B is set on the sealing plate 13, for the pulse modulation of the output power of the laser beam LB, for example, the output power at the valley in the pattern may be gradually increased as shown in FIG. 4A. In the case of the alternate embodiment of the second embodiment, as shown in FIG. 5C, the welding start region 31C is set on the sealing plate 13, the irradiation of the laser beam LB is started on the sealing plate 13, and reaches the fitting portion 30 between the outer can 12 and the sealing plate 13 while pulse-modulating the output power of the laser beam LB in a rectangular wave pattern so that the output power at the valley will be gradually increased. As a result, spots of weld marks 32C are formed. Then, the laser beam LB is output at a constant output power along the fitting portion 30 between the outer can 12 and the sealing plate 13 at a constant speed. As a result, a continuous weld mark 33C is formed.

When the output power at the valley in the pattern is gradually increased during the pulse-modulation of the output power of the laser beam LB, the average output power of the laser beam is gradually increased, and thus the temperature in the sealing plate 13 is greatly increased in accordance with the progress of the irradiation of the pulse-modulated laser beam LB. Accordingly, when the output power at the valley is gradually increased during the pulse-modulation of the output power of the laser beam LB, as shown in FIG. 5C, the temperature in the sealing plate 13 can be increased by a smaller number of pulses than in the case of a simple rectangular wave modulation shown in FIG. 5A. As a result, the length of the welding start region 31B becomes shorter, and the welding can be shifted for a short period to the high speed welding step in which the laser beam LB is output at a constant output power at a higher constant speed.

Also in this case, the pulse modulation may be a pulse modulation having a triangular wave pattern, and furthermore, as shown in FIG. 4B, the output power at the valley in the modulation having the triangular wave pattern may be gradually increased.

### Third Embodiment

### Welding Stop Region

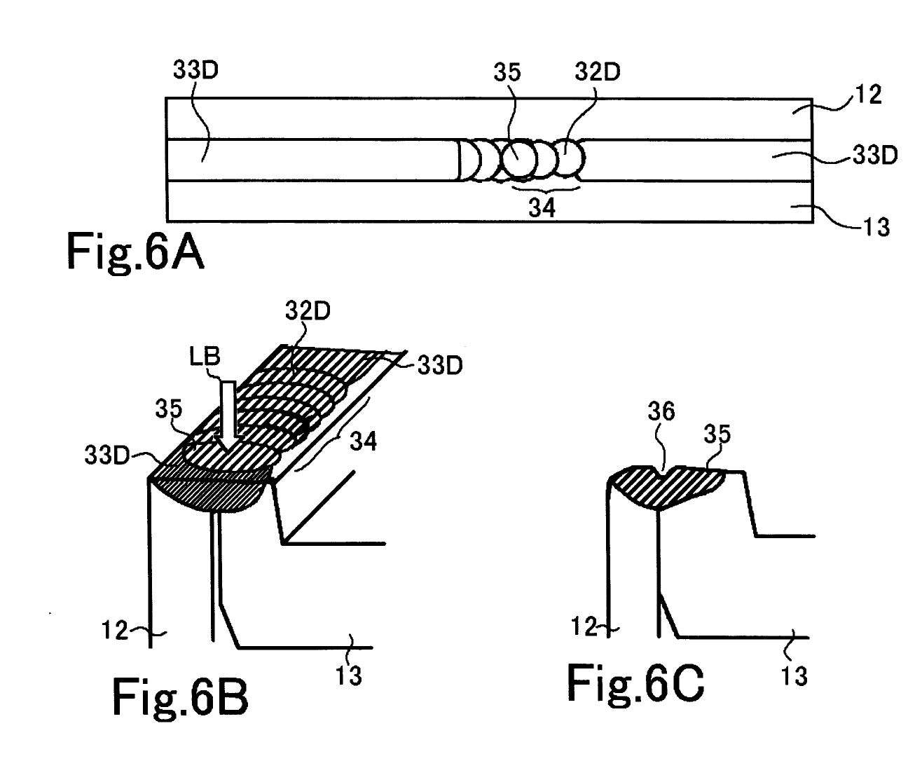

The welded state in a welding stop region in a method for producing a sealed battery in a third embodiment of the invention will be described with reference to FIGS. 6A to 6C. FIG. 6A is an enlarged plan view of a welding stop region in the third embodiment, FIG. 6B is an oblique cross-sectional view of the welding stop region, and FIG. 6C is a schematic cross-sectional view of the melted area after the completion of welding.

A welding stop region 34 in the method for producing a sealed battery in the third embodiment shown in FIG. 6A shows an area that is overlapped with the area corresponding to the welding start region 31A in the method for producing a sealed battery in the first embodiment shown in FIG. 3A. That is, as shown in FIG. 3B, when the laser beam LB is output for scanning around the fitting portion at a constant output power so as to form a continuous weld mark 33D and reaches the welding stop region 34, the laser beam LB is output while pulse-modulating the output power of the laser beam from an area immediately before overlap of the welded areas to at least an area immediately after the overlap, and reaches a welding stop position 35 at a low constant speed. As a result, spots of weld marks 32D are formed.

The reason for this is as follows: in a sealing plate and an outer can made of an aluminum-based metal, when the laser beam LB is applied once again to an area where the laser beam LB has been applied to melt the surface, the absorption factor of the laser beam LB is smaller in the area where the laser beam LB has been applied than in an area where no laser beam LB has been applied for melting, and thus the scanning speed is reduced to supply a sufficient amount of heat. Adopting such method makes the welding speed low but also makes it difficult for the surface to be affected by whether the surface is welded. Therefore, insufficient melting near the welding stop region 34 can be avoided.

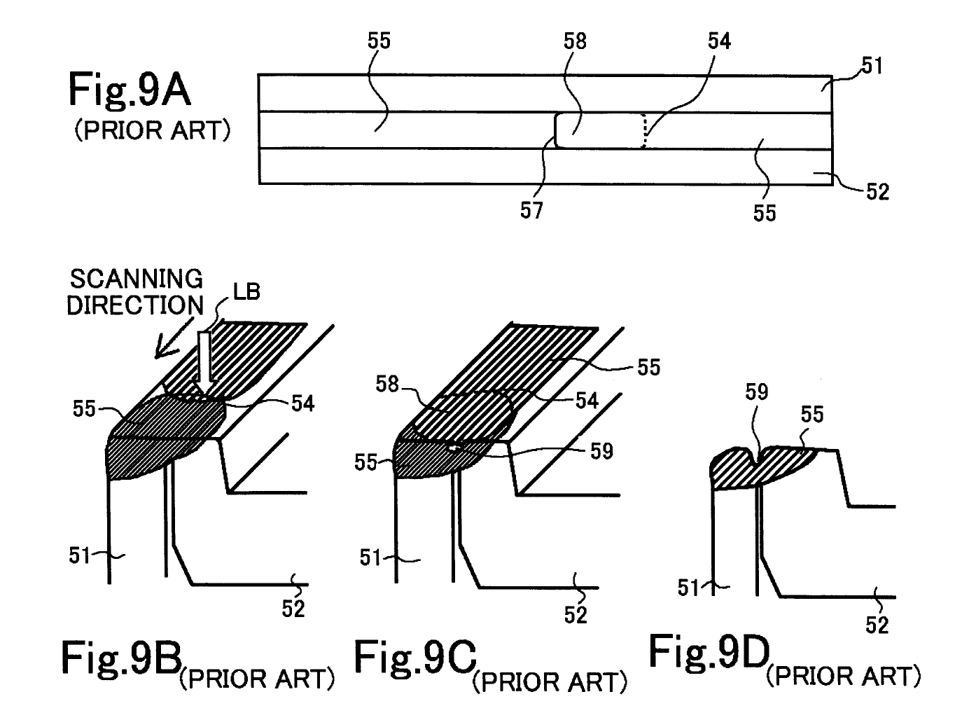

In the welding stop position 35, when the irradiation of a laser beam is suddenly stopped, a hollow or wrinkle 36 may be formed as shown in FIG. 6C. However, in the method, the heat input is smaller than in the case where the laser is output for scanning at a constant output power because the welding is performed while pulse-modulating the output power of the laser beam before the welding stop position 35. Thus, the formed hollow or wrinkle 36 has a smaller depth than that of a hollow or wrinkle 59 in a related art example shown in FIG. 9A, and therefore sufficient welding strength can be obtained.

In the welding stop region 34, when the laser beam LB is output for scanning at a constant output power and then the laser beam is pulse-modulated, the temperature of the sealing plate 13 is reduced with the progress of the scanning. Thus, when the output power at the valley is gradually reduced during the pulse-modulation of the output power of the laser beam LB, the welding stop region 34 is gradually cooled. As a result, it is difficult for a hollow, wrinkle, or the like to be formed in the melted area, and therefore difficult for a welding defect to be caused. In the welding stop region 34 in the method for producing a sealed battery in the third embodiment, the pulse modulation of the output power of the laser beam LB may be a pulse modulation having a rectangular wave pattern or a pulse modulation having a triangular wave pattern.

### Fourth Embodiment

### Welding Stop Region

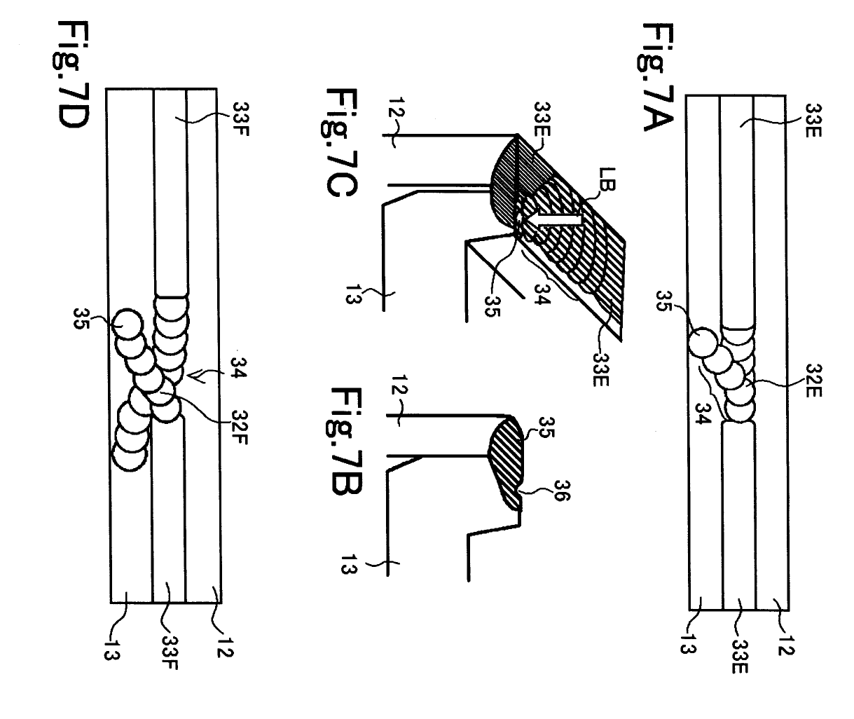

The welded state in a welding stop region in a method for producing a sealed battery in a fourth embodiment of the invention will be described with reference to FIGS. 7A to 7D. FIG. 7A is an enlarged plan view of a welding stop region in the fourth embodiment, FIG. 7B is an oblique cross-sectional view of the welding stop region, FIG. 7C is a schematic cross-sectional view of the melted area after the completion of welding, and FIG. 7D is an enlarged plan view of the welding stop region in an alternate embodiment of the fourth embodiment.

The welding stop region 34 in the method for producing a sealed battery in the fourth embodiment shown in FIG. 7A shows an area that is overlapped with the area corresponding to the welding start region 31A in the method for producing a sealed battery in the first embodiment shown in FIG. 3A. That is, as shown in FIG. 3B, when the laser beam LB is output for scanning around the fitting portion at a constant output power at a constant speed so as to form a continuous weld mark 33E and reaches the welding stop region 34, the laser beam LB is output while pulse-modulating an output power of the laser beam from an area immediately before overlap of the welded areas to at least an area immediately after the overlap, and reaches the welding stop position 35 placed on the sealing plate 13 at a low constant speed. As a result, spots of weld marks 32E are formed.

In the welding stop region 34, when the irradiation of the laser beam LB is stopped after the welded areas are overlapped, the temperature is suddenly changed at the area where the irradiation of the laser beam LB is stopped, and thus a hollow or wrinkle is readily formed. When the welding stop position is set on the fitting portion between the outer can 12 and the sealing plate 13, the melt depth is insufficient at the bottom of the hollow or wrinkle 36 to reduce welding strength as shown in FIG. 6C. To address this, in the method for producing a sealed battery in the fourth embodiment, after the welded areas are overlapped, the laser beam LB is shifted from the fitting portion between the outer can 12 and the sealing plate 13 to the sealing plate 13 and output for scanning while pulse-modulating the output power of the laser beam LB. Then, the output of the laser beam LB is stopped on the sealing plate 13.

As a result, because the position where the irradiation of the laser beam LB is stopped is on the sealing plate 13, even when the hollow, wrinkle 36, or the like is formed, it is divided from the fitting portion 30 between the outer can 12 and the sealing plate 13 as shown in FIG. 7C. Therefore, the welding strength between the outer can 12 and the sealing plate 13 can be maintained, the welded area obtains high-strength, and electrolyte leakage from the sealed battery can be suppressed.

Also in this case, in the welding stop region 34, after the laser beam LB is output for scanning at a constant output power at a constant speed, when the output power at the valley is gradually reduced during the pulse-modulation of the output power of the laser beam LB and the scanning speed is reduced, the welding stop region 34 is gradually cooled. Thus, it is difficult for a hollow, wrinkle, or the like to be formed in the melted area, and therefore difficult for a welding defect to be caused. Furthermore, in the welding stop region 34 in the method for producing a sealed battery in the fourth embodiment, the pulse modulation of the output power of the laser beam LB may be a pulse modulation having a rectangular wave pattern or a pulse modulation having a triangular wave pattern.

The welding stop region 34 in the method for producing a sealed battery in the fourth embodiment shown in FIG. 7A is an area that is overlapped with the area corresponding to the welding start region 31A in the method for producing a sealed battery in the first embodiment shown in FIG. 3A. However, it may be applied to the area corresponding to the welding start region 31B in the method for producing a sealed battery in the second embodiment shown in FIG. 5A to FIG. 5C.

FIG. 7D shows an enlarged plan view of a welding stop region in an alternate embodiment of the fourth embodiment. In FIG. 7D, the same components as in the welding stop region 34 in the method for producing a sealed battery in the fourth embodiment shown in FIG. 7A are shown as the same reference numbers, the additional character “E” is replaced with “F”, and each detailed description will be omitted. The alternate embodiment of the fourth embodiment can also provide similar effects to those from the fourth embodiment. In the alternate embodiment of the fourth embodiment, the irradiation of a laser beam may be started on the sealing plate 13, and the irradiation of a laser beam may be stopped on the fitting portion between the outer can 12 and the sealing plate 13.

What is claimed is:

1. A method for producing a sealed battery comprising:
irradiating a fitting portion between an outer can made of an aluminum-based metal and a sealing plate made of an aluminum-based metal and placed on a mouth portion of the outer can with a laser beam from continuous wave laser welding equipment for welding and sealing,
the laser beam being output for scanning while pulse-modulating an output power of the laser beam in a welding start region, and then the laser beam being output for scanning at a constant output power.

2. The method for producing a sealed battery according to claim 1, wherein the welding start region is set on the sealing plate, irradiation of the laser beam is started on the sealing plate, the laser beam is output for scanning to reach the fitting portion between the outer can and the sealing plate while pulse-modulating the output power of the laser beam, and immediately after that or after the laser beam is output for scanning above the fitting portion beyond a predetermined distance, the laser beam is output for scanning at a constant output power.

3. The method for producing a sealed battery according to claim 1, wherein the output power of the laser beam is gradually increased at a valley of the pulse-modulated output power.

4. The method for producing a sealed battery according to claim 1, wherein in a welding stop region on the fitting portion between the outer can and the sealing plate, the laser beam is output for scanning while pulse-modulating the output power of the laser beam from an area immediately before the overlap of welded areas to at least an area immediately after the overlap.

5. The method for producing a sealed battery according to claim 2, wherein in a welding stop region on the fitting portion between the outer can and the sealing plate, the laser beam is output for scanning while pulse-modulating the output power of the laser beam from an area immediately before the overlap of welded areas to at least an area immediately after the overlap.

6. The method for producing a sealed battery according to claim 3, wherein in a welding stop region on the fitting portion between the outer can and the sealing plate, the laser beam is output for scanning while pulse-modulating the output power of the laser beam from an area immediately before the overlap of welded areas to at least an area immediately after the overlap.

7. The method for producing a sealed battery according to claim 4, wherein in the welding stop region on the fitting portion between the outer can and the sealing plate, after the welded areas are overlapped, the laser beam is output for scanning from the fitting portion between the outer can and the sealing plate to the sealing plate while pulse-modulating the output power of the laser beam and is stopped on the sealing plate.

8. The method for producing a sealed battery according to claim 5, wherein in the welding stop region on the fitting portion between the outer can and the sealing plate, after the welded areas are overlapped, the laser beam is output for scanning from the fitting portion between the outer can and the sealing plate to the sealing plate while pulse-modulating the output power of the laser beam and is stopped on the sealing plate.

9. The method for producing a sealed battery according to claim 6, wherein in the welding stop region on the fitting portion between the outer can and the sealing plate, after the welded areas are overlapped, the laser beam is output for scanning from the fitting portion between the outer can and the sealing plate to the sealing plate while pulse-modulating the output power of the laser beam and is stopped on the sealing plate.

10. The method for producing a sealed battery according to claim 7, wherein the output power of the laser beam in the welding stop region is gradually reduced at a valley of the pulse-modulated output power.

11. The method for producing a sealed battery according to claim 8, wherein the output power of the laser beam in the welding stop region is gradually reduced at a valley of the pulse-modulated output power.

12. The method for producing a sealed battery according to claim 9, wherein the output power of the laser beam in the welding stop region is gradually reduced at a valley of the pulse-modulated output power.

13. A method for producing a sealed battery, the method comprising:
irradiating a fitting portion between an outer can made of an aluminum-based metal and a sealing plate made of an aluminum-based metal and placed on a mouth portion of the outer can with a laser beam from continuous wave laser welding equipment for welding and sealing,
in a welding stop region on the fitting portion between the outer can and the sealing plate, the laser beam being output for scanning while pulse-modulating an output power of the laser beam from an area immediately before the overlap of welded areas to an area immediately after the overlap.

14. The method for producing a sealed battery according to claim 13, wherein in the welding stop region on the fitting portion between the outer can and the sealing plate, after the welded areas are overlapped, the laser beam is output for scanning from the fitting portion between the outer can and the sealing plate to the sealing plate while pulse-modulating the output power of the laser beam and is stopped on the sealing plate.
